(19) United States
(12) Patent Application Publication
(10) Pub. No.: US 2023/0289365 A1
(43) Pub. Date: Sep. 14, 2023

(54) SYSTEMS AND METHODS FOR MONITORING DOCUMENT SYNCHRONIZATION

(71) Applicant: Synergy, Inc., Dedham, MA (US)

(72) Inventors: Jonathan Towles, Dedham, MA (US); Daniel D.J. Yun, Buffalo Grove, IL (US)

(21) Appl. No.: 18/120,518

(22) Filed: Mar. 13, 2023

Related U.S. Application Data
(60) Provisional application No. 63/319,380, filed on Mar. 13, 2022.

(51) Int. Cl. G06F 16/27; G06F 16/93

(52) U.S. Cl. CPC G06F 16/27; G06F 16/93

(57) ABSTRACT

A document synchronization system operates in cooperation with a word processing application such as Word, an operating system such as Windows, and a web-based system to monitor and register operations performed on a document and provide the user or users with information on the operations and about the document status. Additionally, the user or users are provided with options to manage the document in the event of a synchronization problem.

### CROSS-REFERENCES

This application claims priority of U.S. provisional application Ser. No. 63/319,380 filed Mar. 13, 2022 and titled “Systems and Methods for Monitoring Document Synchronization” by the present inventors.

### BACKGROUND

A benefit of working on documents using computers connected via a network such as the Internet is the ability to work on the same document with one or more other users over the network. Another benefit is the ability to make changes to a document stored remotely such as in a remote server or in the cloud. An additional benefit is the ability to make a local copy of a remotely stored document and then merging the locally-made changes into the remote storage.

Document synchronization is a key element in a shared-document environment, such as, an environment where one user is sharing the document with other users or an environment where a document is stored remotely. The users need to know that document changes are being transmitted and saved properly. If not, document changes can be lost, document portions improperly overwritten, improperly marked and work delayed by the need to recover and rework documents.

Conventional document synchronization systems and methods generally provide little information to the users. Making document synchronization information available to users enhances collaboration because the users can have confidence in the accuracy of the document. Conventional document synchronization systems and methods often do not provide meaningful control to the users when a synchronization problem occurs. Where synchronization problems are occurring, information and some control over outcomes can help to reduce user frustration and can obviate some document development problems.

For the foregoing reasons, there is a need for new ways to monitor document synchronization including elements for providing synchronization information and control mechanisms to the user.

### SUMMARY

The presently disclosed methods and systems for monitoring document synchronization operate in cooperation with a word processing application such as Word, an operating system such as Windows, and a web-based system to monitor and register operations performed on a document and provide the user or users with information on the operations and about the document status. Additionally, the user or users are provided with options to manage the document in the event of a synchronization problem.

In one embodiment, the synchronization application connects through the SharePoint Client Object Model (CSOM) and Microsoft Graph API (MSGAPI). SharePoint is a web-based collaborate platform that integrates with Microsoft Office and accordingly document processing applications such as Microsoft Word. MSGAPI is a RESTful web API that enables access to Microsoft Cloud service resources. Representational State Transfer (REST) is an architectural approach to designing web services. The synchronization application makes RESTful calls in coordination with operations on document made by the user and uses the resulting information to keep the user informed on the save status of the document on a frequent basis. If there is a problem with saving the document, the user is provided with options for saving the document. Providing the user with information and options enables the user to respond to a problem in a useful way. The informed user can save a document before changes are lost or before changes are made inappropriately to a central copy of the document. The ability to respond to a document synchronization problem in a way that prevents synchronization errors may reduce the user frustration with collaborative and cloud-based systems when the collaborate and cloud-based systems operate poorly.

Embodiments of the document synchronization method applied to a document processing system include monitoring document synchronization calls and saves to a central document storage and management system, maintaining a record of synchronization calls and saves including outcome data of each synchronization call and save, controlling a notification device to show status of a document in response to the outcome data, and enabling document control actions when a stored threshold number of failed document synchronization calls and saves is exceeded. This embodiment provides information and control to the user enabling improved document synchronization and enables the user to work more efficiently and with greater confidence in the document status.

In an alternative embodiment, the method further includes making operation calls in coordination with document operations in the document processing system. In a first alternative arrangement, the operation calls are RESTful calls. In a second alternative arrangement, monitoring monitors operations at the central storage and management system. In another alternative arrangement, the record includes all document operations. In a further alternative arrangement, the record includes successful synchronization calls, failed synchronization calls, successful document saves and failed document saves.

Another embodiment of the document synchronization method includes controlling a notification device to present a visual notification in a graphical user interface. In an alternative arrangement, the notification device includes a fail notification, a warning notification and a pass notification.

Another embodiment of the document synchronization method includes at least one document save action in the document control actions. In an alternative arrangement, the document control actions include a local save action with a conflict date and a local save action with a user-selected document name.

Another embodiment of the document synchronization method includes enabling a suspension of action while the monitoring step continues, and controlling a notification device to indicate when document actions may resume.

Other embodiments of the document synchronization system include a non-transitory computer-readable storage medium, storing a computer software instruction, the computer software instruction, when being executed, causing a document processing system to perform a method including monitoring document synchronization calls and saves to a central document storage and management system. This embodiment further maintains a record of synchronization calls and saves including outcome data of each synchronization call and save, controls a notification device to show status of a document in response to the outcome data, and enables document control actions when a stored threshold number of failed document synchronization calls and saves is exceeded. In an alternative arrangement, the method further includes making operation calls in coordination with document operations in the document processing system. In another alternative arrangement, the record includes all document operations. In a further alternative arrangement, the record includes successful synchronization calls, failed synchronization calls, successful document saves and failed document saves.

Another embodiment is a computing system for synchronization including an interface with a central document synchronization system, a document interface to receive data about document operations, a user interface including a notification device, a monitor to document synchronization through the document interface and the interface with the central document synchronization system and to generate document status data, and a synchronization manager to operate the notification device in response to the document status data.

The present invention together with the above and other advantages may best be understood from the following detailed description of the embodiments of the invention illustrated in the drawings, wherein:

### DRAWINGS

FIG. 1 is a flow chart of the operation of an embodiment of a system for monitoring document synchronization;

FIG. 2 is a flow chart of the operation of monitoring document operations of the embodiment of FIG. 1;

FIG. 3 is a block diagram of an example of user notifications generated by embodiments of the system of monitoring document synchronization;

FIG. 4 is an illustration of an example panel showing saves and synchronization in an embodiment of the system of monitoring document synchronization; and

FIG. 5 is a block diagram of a system for monitoring document synchronization according to principles of the invention.

### DESCRIPTION

Systems and methods for document synchronization in collaborative and networked environments provide document users with information about document synchronization and provide options to respond. The information includes document synchronization success or failure. The options to respond include, for example, different ways of saving a document in the event of a synchronization problem.

In one embodiment, the synchronization application connects through the SharePoint Client Object Model (CSOM) and Microsoft Graph Application Programming Interface (MSGAPI). SharePoint is a web-based collaborative platform that integrates with Microsoft Office. SharePoint also integrates with document processing applications such as Microsoft Word. SharePoint enables storage, retrieval, searching, archiving, tracking, management, and reporting on electronic documents and records. The Sharepoint functions may be designed around various legal, information management, and process requirements in organizations. SharePoint also provides search and data display functionality. SharePoint's integration with Microsoft Windows and Microsoft Office enables collaborative real-time editing, and encrypted/information rights managed synchronization. This capability may be used to replace an existing corporate file server, and is typically coupled with an enterprise content management policy. MSGAPI is a RESTful web API that enables access to Microsoft Cloud service resources. Representational State Transfer (REST) is an architectural approach to designing web services. SharePoint and MSGAPI do not provide document synchronization information and control capabilities to the users working on a share document.

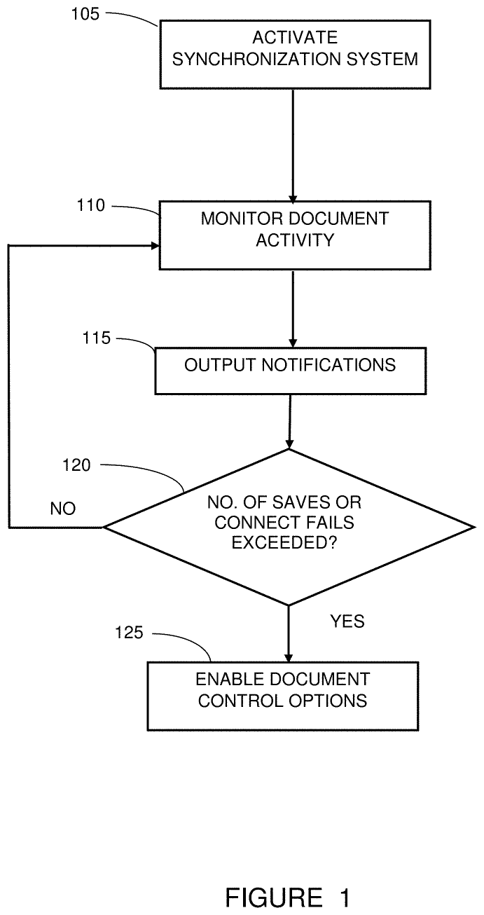

FIG. 1 is a flow chart of the operation of an embodiment of a document synchronization system. The synchronization system is installed in this embodiment as an Add-in to Microsoft Word. An Add-in is a software application that interacts with the content in a Word document and that creates requests to act on Word objects and synchronizes object state.

At step 105, the synchronization system is activated. To use the synchronization system, a user in the present example embodiment opens a SharePoint/OneDrive document in Microsoft Word for Desktop. The user then provides credentials (such as “logging in”) to authenticate the synchronization system. The credentials are provided through the Microsoft Authentication Library (MSAL). Authorization tokens are automatically renewed via the Google APIs client library (GAPI) and the SharePoint Client Object Model (CSOM).

At step 110, the synchronization system monitors document synchronization calls and saves. The synchronization system makes RESTful calls in coordination with operations on the document made by the user. The synchronization system further monitors SharePoint and Microsoft OneDrive for save events. The synchronization system uses the resulting information of the monitoring to keep the user informed on the save status of the document on a frequent basis. The output provided to the user is described in greater detail below. If there is a problem with saving the document, the user is provided with options for saving the document.

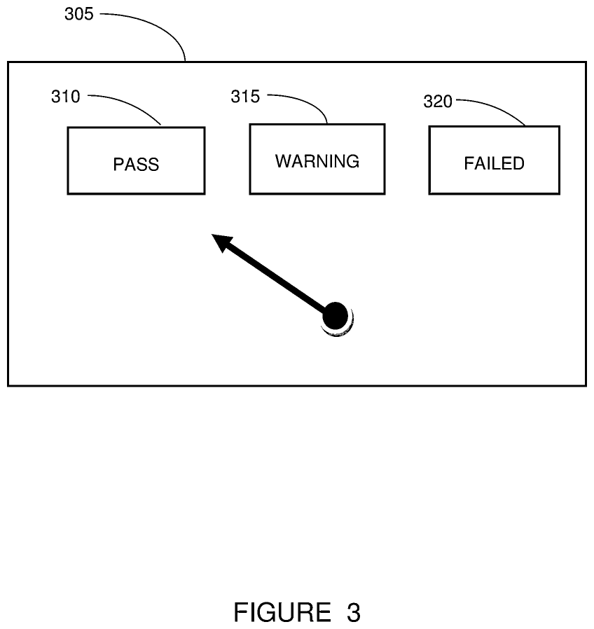

At step 115, the synchronization system provides output to a notification indicator and in some embodiments, to an events task pane. The synchronization system monitors and notifies the user of document save status. The notification is, for example, a visual notification in a graphical user interface (GUI). The notification in one arrangement is the ribbon and task pane using Microsoft Visual Studio Tools for Office (VSTO). Another example notification is shown in FIG. 3 which shows a set of document status indications which could alternatively include color.

At step 120, the synchronization system determines whether the number of failed saves or failed connection attempts has exceeded a stored threshold number. In the present example, that threshold number is five. If the threshold is not exceeded, the synchronization system continues to monitor the document activity, step 110. If the threshold is exceeded, the synchronization system proceeds to step 125.

At step 125, the synchronization system presents document control options to the user. At a high level, the control options enable the user to respond in a meaningful way to a situation where the document is not synchronizing properly. Example options for document control include the capability of saving a copy of the document to a local location with a conflict date and the capability of saving the document to a local location with a name selected by the user.

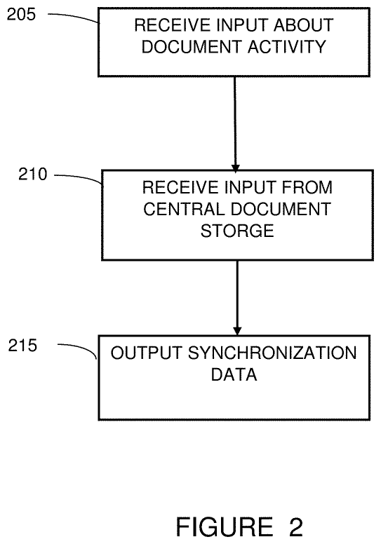

FIG. 2 is a flow chart of the operation of the monitoring portion of the synchronization system, that is, step 110 of FIG. 1 in greater detail. Inside the monitor, the synchronization system monitors document synchronization calls and saves.

At step 205, the monitor receives as input signals about document activity. In the present embodiment, the monitor watches the RESTful calls resulting from operations on the document made by the user.

At step 210, the monitor receives as input signals from the central storage and management system. In the present embodiment, the monitor watches SharePoint and Microsoft OneDrive for save events. The monitor also watches for failures to connect with the central storage and management system.

At step 215, the monitor outputs the synchronization data it collects to the synchronization system. This output is used to keep the user informed on the save status of the document on a frequent basis. The output is further used to determine whether there is a problem saving the document.

FIG. 3 is a block diagram of an example arrangement of notifications of document save status provided to the user in the user interface. The diagram illustrates a panel 305 in the graphical user interface (GUI).

The indications in FIG. 3 provide information about how well a document has synchronized. For example, a failed notification 320 means that synchronization calls have failed five (5) times or more, or alternatively, that connectivity was lost and has not re-established after five (5) attempts. A warning notification 315 means that synchronization has failed fewer than five (5) times and the synchronization application is trying to reconnect. A pass notification 310 means that connectivity and synchronization are in good working order. There are many other possible alternative embodiments to the panel shown in FIG. 3. In this figure, an arrow indicates which notification is active, however, more likely, the notification would be highlighted against the background color or in an alternative arrangement the various warnings would be different colors. In an alternative embodiment, the notification is sound or a set of sounds. The user notification should not be considered limited to the arrangements described here.

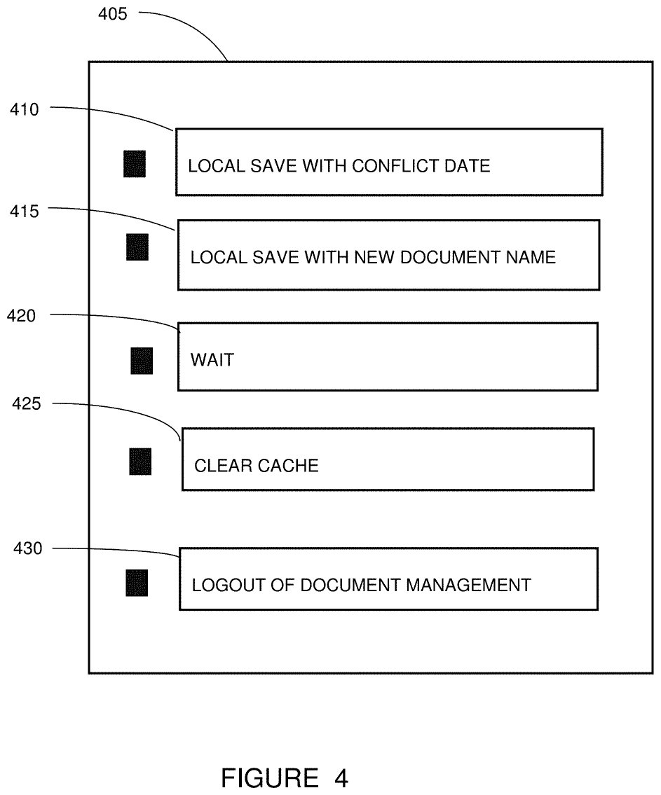

FIG. 4 is a block diagram of an example panel 405 showing saves and synchronization options. In a case of a failed save or a network disconnect, the user is prompted with document save options. The save options enable the user to save the document without losing data. The save options include saving a copy to the same location with a conflict date 410, saving the document to a local location with a name selected by the user 415, and waiting for the network connection to re-establish 420 so that the document auto-save feature can occur normally.

Further embodiments of the synchronization application include an events log shown to the user in a task pane. The log provides, for example, save events. Further alternative embodiments of the synchronization application enable a user to clear the browser cache 425 and to logout of a Microsoft account 430. Still further alternative embodiments provide audible alerts about synchronization in addition to or instead of visual alerts.

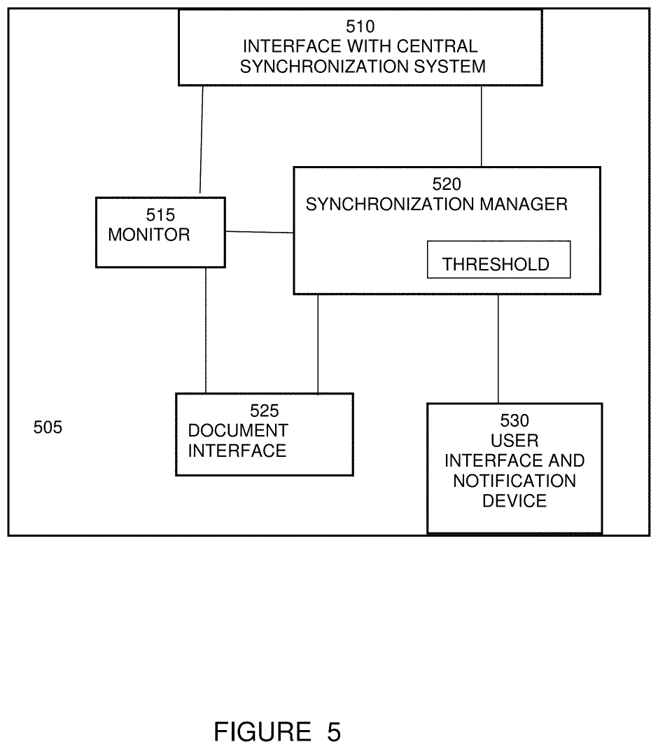

FIG. 5 is a block diagram of the synchronization system 505. The synchronization system 505 operates in a collaborative document environment in which documents are centrally stored and edited on multiple local devices by users. The synchronization system 505 is particularly important and valuable in situations where users' contributions need to be accurately recorded in the shared document and where it is critical that no contributions are lost. One of these situations is in biotechnology document creation and another of these situations is medical writing. In the embodiment described here, the synchronization system 505 is part of a computer running Microsoft Windows and interacts with a central storage and document management system using Microsoft Sharepoint through an interface 510. The synchronization system 505 has a monitor 515 that monitors document activity, specifically synchronization calls and saves through a document interface 525. The monitor interacts with a central document management and storage system (not shown) through the central system interface 510 to watch and record success or failure of the synchronization calls and saves. The synchronization system 505 has a synchronization manager 520 that maintains the output of document activity from the monitor 515. The synchronization manager 520 provides information to the document user through a user interface 530. The synchronization manager 520 provides information with regard to document status using the stored record of synchronization calls and saves and particularly with regard to a stored threshold number as described above with regard to FIGS. 1-4. The example threshold number of failed saves or failed synchronization calls is five (5) however this number could be different and should not be considered limiting.

The embodiment above is implemented in a Microsoft environment using Microsoft tools however alternative embodiments implemented in other web-based platforms, other operating systems and other document processing applications are possible, for example Apple Pages and Google Docs.

It is to be understood that the above-identified embodiments are simply illustrative of the principles of the invention. Various and other modifications and changes may be made by those skilled in the art which will embody the principles of the invention and fall within the spirit and scope thereof.

We claim:

1. A document synchronization method applied to a document processing system, the method comprising:
monitoring document synchronization calls and saves to a central document storage and management system;
maintaining a record of synchronization calls and saves including outcome data of each synchronization call and save;
controlling a notification device to show status of a document in response to the outcome data; and
enabling document control actions when a stored threshold number of failed document synchronization calls and saves is exceeded.

2. The method of claim 1 further comprising making operation calls in coordination with document operations in the document processing system.

3. The method of claim 2 wherein the operation calls are RESTful calls.

4. The method of claim 1 wherein monitoring further comprises monitoring operations at the central storage and management system.

5. The method of claim 1 wherein the record includes all document operations.

6. The method of claim 1 wherein the record includes successful synchronization calls, failed synchronization calls, successful document saves and failed document saves.

7. The method of claim 1 wherein controlling a notification device further comprises presenting a visual notification in a graphical user interface.

8. The method of claim 1 wherein the notification device includes a fail notification, a warning notification and a pass notification.

9. The method of claim 1 wherein the document control actions include at least one document save action.

10. The method of claim 9 wherein the at least one save action includes a local save action with a conflict date and a local save action with a user-selected document name.

11. The method of claim 9 further comprising enabling a suspension of action while the monitoring step continues; and
controlling the notification device to indicate when document actions may resume.

12. A non-transitory computer-readable storage medium, storing a computer software instruction, the computer software instruction, when being executed, causing a document processing system to perform:
monitoring document synchronization calls and saves to a central document storage and management system;
maintaining a record of synchronization calls and saves including outcome data of each synchronization call and save;
controlling a notification device to show status of a document in response to the outcome data; and
enabling document control actions when a stored threshold number of failed document synchronization calls and saves is exceeded.

13. The storage medium according to claim 12, further causing the document processing system to perform:
making operation calls in coordination with document operations in the document processing system.

14. The storage medium according to claim 12 wherein the record includes all document operations.

15. The storage medium according to claim 12 wherein the record includes successful synchronization calls, failed synchronization calls, successful document saves and failed document saves.

16. A computing system for synchronization, the computer system comprising:
an interface with a central document synchronization system;
a document interface to receive data about document operations;
a user interface including a notification device;
a monitor to document synchronization through the document interface and the interface with the central document synchronization system and to generate document status data; and
a synchronization manager to operate the notification device in response to the document status data.
